(19) United States
(12) Patent Application Publication
(10) Pub. No.: US 2005/0044243 A1
(43) Pub. Date: Feb. 24, 2005

(54) System for toll-free or reduced toll internet access

(75) Inventors: Raja P. Narayanan, Ladera Ranch, CA (US); Yoshihiro Oba, Torrance, CA (US); Shinichi Baba, Irvine, CA (US)

Correspondence Address: Mark Kendick;PILLSBURY WINTHROP LLP, 725 South Figueroa Street, Suite 2800, Los Angeles, CA, 90017, US

(73) Assignee: TOSHIBA AMERICA INFORMATION SYSTEMS, INC.

(21) Appl. No.: 10/644,607

(22) Filed: Aug. 19, 2003

(51) Int. Cl. G06F 15/16; H04K 1/00; H04L 9/00; G06F 17/60

(52) U.S. Cl. 709/229; 705/52

(57) ABSTRACT

A computing node accesses toll-free or at a reduced toll, a subscriber server through an access network and a global communications network, i.e., the Internet. A computing node generates a plurality of network packets including at least one packet having destination identification information. A client within the computing device receives the at least one packet and transmits the destination identification information from the at least one packet to a management server. The management server verifies the destination identification information corresponds to a registered subscriber and sends an authorization signal to the client. The client allows the plurality of network packets, which have the destination identification information corresponding to a registered subscriber server, to be transmitted to a registered subscriber server.

### BACKGROUND OF THE INVENTION

The use of public internet access at airports, hotels, and bookstores, is expanding. Public internet access locations include hotspots at bookstores or coffee shops, or commercial establishments at airports, train stations, or libraries. Public internet access allows connection to a global communications network. Users of public internet access may utilize a variety of computing nodes to connect to the public internet access locations, and then the global communications network. The variety of computing nodes may include personal digital assistants, cellular phones, laptop computers, network computers, and desktop computers. The computing nodes may connect to the public internet access locations via wireless or wired topologies.

Currently, in order to utilize public internet access, a user of the computing node must be a subscriber of a service provider that is affiliated with the public internet access location. Alternatively, the user of the computing node could make a per usage payment directly to the public internet access provider. For example, Sprint PCS, T-Mobile, or Cingular could have an agreement with a coffee shop/bookstore to allow its high-end cellular subscribers to utilize the coffee shop/bookstore Internet access location. Alternatively, the user of the computing node could pay the coffee shop/bookstore a flat fee for a certain number of hours of connection to the public internet access location.

There is no present system to allow a business that is providing a service on the Internet to provide the user of a computing node with the benefit of toll-free access or reduced toll access to the Internet. Reduced toll access could be offering access at a reduced cost from normal rates, or offering access to the Internet at a nominal cost. In other words, a business may desire to attract computing node users to the business's website and specifically may desire to attract users who are located at public internet access locations, but does not want the users of the computing nodes to be charged a substantial fee to access the Internet at the public internet access locations. Thus, these businesses would like to bear the responsibility for paying for all or a substantial portion of the cost for the user of the computing nodes to access to the business's servers. The entities with which the businesses would have to make business arrangements, or business models, are the access service providers and the toll-free and the reduced toll service providers.

For example, there is currently no simple mechanism for Toshiba America Information Systems to provide toll-free technical support from its technical support website if the user is logging onto the Internet from a public Internet access location, such as a hotspot. Economically, it is not advantageous to ask a user of a computing node to pay a fee to a service provider or the hotspot provider in order to receive technical support.

Presently, a solution that provides toll-free access to users at public internet access locations requires a special gateway to be installed at the public internet access location. This increases the cost to the public internet access provider because hardware or software at the existing public internet access locations needs to be modified and a significant amount of time may be needed for deployment. Illustratively, access points, access routers, and authentication agents may all need to be modified to accommodate the special gateway.

Therefore, a service needs to be provided that can allow users of computing nodes to receive toll-free Internet access or reduced toll access transparently. In other words, the toll-free or reduced toll Internet access should be able to be deployed on current network equipment without extensive modification.

### DESCRIPTION OF THE FIGURES

FIG. 1 illustrates a toll-free network system according to an embodiment of the present invention;

FIG. 2 illustrates a toll-free Internet service system for a single computing node according to an embodiment of the present invention;

FIG. 3 illustrates a toll free client according to an embodiment of the present invention; and

FIG. 4 illustrates a flowchart describing a flow of packets in a toll-free client according to an embodiment of the present invention.

### DETAILED DESCRIPTION OF THE INVENTION

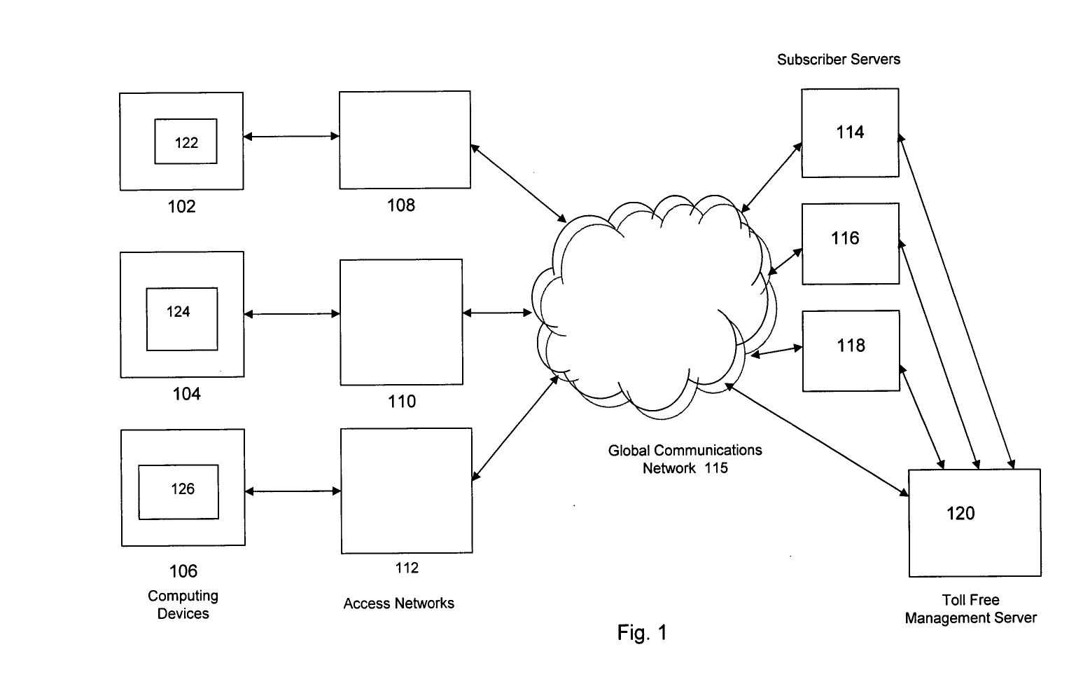

FIG. 1 illustrates a toll-free or reduced toll network system according to an embodiment of the present invention. The network system may provide a computing node toll-free access or reduced toll access to a subscriber server through an access network and the global communications network, e.g., Internet. Under certain operating conditions, the computing node may not be charged a fee to connect to the access network, and subsequently the global communications network and subscriber server. Under other operating conditions, the computing node may be charged a reduced rate or a nominal fee to connect to the access network, and subsequently, the global communications network and the subscriber server. For simplicity, in the remainder of the patent application, the term “toll-free” will be utilized with the understanding that the term “reduced toll” could be substituted for the term “toll-free” or utilized instead of the term “toll-free”. In other words, in all of the embodiments of the present invention, the system, computing node, or client could be utilized to provide “reduced toll” service.

A toll-free network system includes a plurality of computing nodes 102, 104, and 106, at least one access network 108, 110, and 112, a global communication network 115, a plurality of toll-free subscriber servers 114, 116, and 118, and at least one toll-free Internet management server 120. The plurality of computing nodes 102, 104, and 106 may each have a toll-free client 122, 124, and 126 installed.

In an embodiment of the invention, the plurality of toll-free subscriber servers 114, 116, and 118 registers with the toll-free management server 120. The toll-free management server 120 may maintain a database or a registration table. The database or registration table identifies which of the plurality of toll-free subscriber servers 114, 116, and 118 have registered to allow toll-free or reduced toll service. The toll-free subscriber servers 114, 116, and 118 would like to offer toll-free or reduced toll service to users utilizing the network partnered with, controlled by, or managed by the owner of the toll-free Internet management server 120. The toll-free Internet management server 120 may be owned or controlled by any toll free service provider such as MCI, Sprint, Yahoo, AOL, etc.

These toll free service providers, e.g., MCI, Sprint, Yahoo, AOL, etc., establish business relationships with an access provider controlling Internet access via access networks 108, 110, and 112, to ensure toll free access is provided to users who are authenticated by the toll free service provider via the toll-free Internet management server 120. The access network providers (owners or controllers of access network 108, 110, and 112) do not require a change in any function implemented in the access network for the toll-free service of the present invention. In some circumstances, the toll-free service provider and the access provider may be one and the same entity. Under some operating conditions, the toll-free service provider and the access provider are unique and separate entities. Examples of access providers may include Sprint, Wayport, T-Mobile, or any Internet Service Provider. If the toll-free service provider and the access provider are unique and separate entities there may be a predetermined agreement between the toll-free service provider and the access provider to allow users of the computing nodes 102, 104, and 106 to access the access networks 108, 110, and 112 to connect to the global communication network 115, and subsequently the toll-free subscriber servers 114, 116, and 118.

The owner or controlling entity of the plurality of toll-free subscriber servers 114, 116, and 118 may be a business, (small, medium, or large) that wants to provide toll-free access to its servers 114, 116, and 118 through the owner of the toll-free Internet management server 120. The network system allows for the owners or controllers of the toll-free subscriber servers 114, 116, and 118 to be charged by the toll-free service provider for access to the toll-free subscriber servers 114, 116, and 118 by the computing nodes 102, 104, and 106 through the access networks 108, 110, and 112, and the global communications network 115. If the owner or controller of the access networks 108, 110, and 112, i.e., the access service providers, are not owned by the same entity as owns or controls the toll-free management server 120, i.e., the toll-free service provider, the toll-free service provider needs to establish a business relationship or business model with the access service provider.

A toll-free client 122, 124, and 126 may be a software application resident within a memory of computing nodes 102, 104, and 106 that is executed by the computing nodes 102, 104, and 106. Alternatively, the toll-free client 122, 124, and 126 may be resident on a removable media including memory, such as a memory stick, smart card, or memory card, where the toll-free client is executed by the insertion of the removable media including memory into the computing node, e.g., a computing node media reader. In an embodiment of the invention, the computing nodes 102, 104, and 106 enter areas or geographic locations, such as airports, coffee shops, etc., which allow access to the global communications network 115, e.g., Internet, through access networks 108, 110, and 112. Upon sensing the access networks 108, 110, and 112, the toll-free client 122, 124, and 126 attempts to be authenticated by the toll-free management server 120 by transmitting an authentication request including an embedded user identifier or embedded identifier through the access networks 108, 110, and 112 and the global communications network 115 to the toll-free management server 120. The toll-free management server 120 receives the authentication request, verifies whether the embedded identifier is authentic, and if the embedded identifier is authentic, then the toll-free management server 120 transmits an authentication signal back to the toll free client 122, 124, and 126 resident in the computing devices 102, 104, and 106.

In an embodiment of the invention, the toll free management server 120 may, as an option, rely on an existing user authentication server (e.g., a RADIUS or a DIAMETER server) to execute this function, or may not get involved in the process, i.e., have the toll-free client 122, 124, and 126 communicate directly with an existing user authentication server. In this embodiment of the invention, the existing user authentication server may be located on the global communications network 115. In an embodiment of the invention, the existing user authentication server may be located on a wide area network (WAN) or a local area network (LAN). If the toll-free access provider and the access network provider are different entities, an accounting event is triggered between the access network provider and the toll-free service provider to begin the calculation of the usage of the access network provider by the toll-free service provider.

After the toll-free clients 122, 124, and 126 of the computing nodes 102, 104, and 106 are authenticated, applications on the computing nodes create network packets, including a destination packet, which are to be transmitted to the toll-free subscriber servers 114, 116, and 118. Under certain operating conditions, the destination packet may be the first packet. Under other operating conditions, the destination packet may be a plurality of packets including the first packet. Under other operating conditions, the destination packet may be a network packet other than the first packet. Under certain operating conditions, the destination packet may be a plurality of packets not including the first packet. The destination packet may include destination identification information. In other words, the destination packet may include destination information indicative of a subscriber server with which the computing node is to communicate.

The toll-free client 122, 124, and 126 receives the network packets including the destination packet from an application in the computing node and extracts a destination information or destination identification information from the destination packet. The toll-free client 122, 124, and 126 does not transmit the network packets until it has determined whether the network packets are being transmitted to a registered toll-free subscriber server (or registered subscriber server) 114, 116, and 118. Illustratively, the destination identification information or destination information could be an Internet Protocol (IP) address or a Uniform Resource Locator (URL). In one embodiment of the invention, the toll-free client 122, 124, and 126 verifies with the toll-free management server 120 whether the destination identification information of the analyzed packet is a registered toll-free subscriber server, such as subscriber servers 114, 116, and 118. In this embodiment of the invention, the toll-free management server 120 verifies whether the transmitted destination identification information corresponds to one of the registered subscriber servers 114, 116, and 118. If verification occurs, the toll-free management server 120 sends an authorization message or signal to the toll-free client 122, 124, and 126 in the computing devices 102, 104, and 106.

The toll-free client 122, 124, and 126 receives the authorization message or signal from the toll-free management server 120. After receipt of the authorization message or signal from the toll-free management server 120, the toll-free client 122, 124, and 126 releases the network packets to the subscriber servers 114, 116, and 118 corresponding to the destination identification information located in the network packets. For example, if the destination identification information is an IP address of a technical support server, the toll-free client 122, 124, and 126 releases the network packets and allows for the network packets to be transmitted to the technical support server. In other words, the toll-free client 122, 124, and 126 is acting as a filter to filter-out any packets that do not have destination identification information corresponding to the subscriber servers 114, 116, and 118. In an embodiment of the present invention, the toll-free client 122, 124, and 126 transmits the plurality of network packets to the subscriber servers 114, 116, and 118.

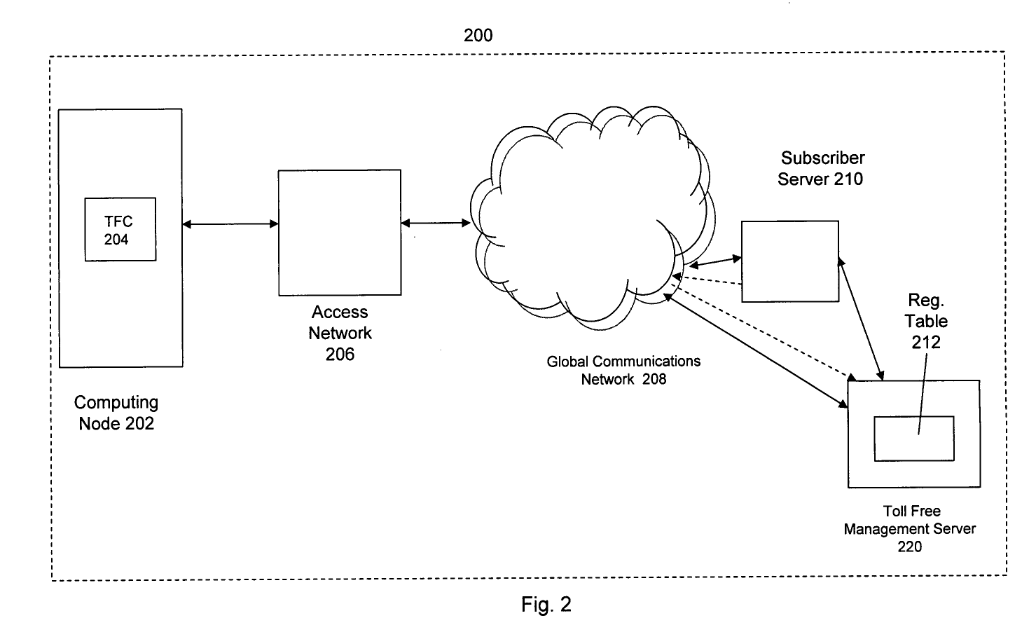

FIG. 2 illustrates a toll-free Internet service system for a single computing device according to an embodiment of the present invention. The toll-free Internet service system 200 includes a computing node 202, a toll-free client 204, an access network 206, a global communications network 208, a toll-free subscriber server 210, and a toll-free management server 220. The toll-free management server 220 includes a registration table 212.

In the embodiment of the invention illustrated in FIG. 2, the subscriber server 210 registers with the toll-free management server 220. As described above, the registration of the toll-free subscriber server 210 identifies that the owner of the toll-free subscriber server 210 will pay a predetermined fee to allow access to its server 220 by users of computing nodes. The fee may be paid to a toll-free service provider, which in turn may have an arrangement with an access network provider. The access is provided through network links owned or controlled (explicitly or via a partnership with an access provider) by the owner of the toll-free management server 220, i.e., the toll-free service provider. The predetermined fee paid by the owner of the subscriber server 210, e.g., the toll-free subscriber, to the owner of the toll-free management server 220 (the toll-free service provider) may be a set fee, a fee based upon the number of accesses, or a fee based upon the number of accesses and the time of the accesses, or any representative business model that may be agreed upon by the toll-free service provider and the toll-free subscriber.

The registration process includes the subscriber server 210 providing the toll-free management server 220 with destination identification information or destination information of, or corresponding to, the subscriber server 210. Destination identification information may be IP addresses, URLs, or other identification methods. In an embodiment of the invention, the subscriber server 210 may include multiple computers and, thus, multiple destination identification IDs. Illustratively, the toll-free subscriber server 210 may want to register a plurality of destination identification information IDs at the toll-free management server 220. In an embodiment of the invention, the subscriber server 210 may register the destination identification information through the global communication network 208 to the toll-free management server 220. This may occur if the toll-free management server 220 and the subscriber server 210 are located on different LANs or WANs.

The toll-free management server 220 receives the destination identification information or destination information for the subscriber server 210. A registration table 212 is located within the toll-free management server 220. The registration table 212 includes a list of the destination identification information or destination information for all of the subscriber servers 210 that have registered with the toll-free management server 220 to provide toll-free access. For example, if ten different subscribers would like to register two destination identifiers each, the registration table 212 would include twenty entries.

The actual entries in the registration table 212 may be static or dynamic. If the actual entries are static, then the destination identifiers for the toll-free subscriber servers would not change. If the entries in the registration table are dynamic, the number of destination information identifiers would remain the same, but the values of the destination identifiers would be constantly changing. This may be beneficial in environments where new servers are constantly being added by toll-free subscribers or in environments where the destination identifiers, e.g., IP addresses or URLs, are continuously being changed for security or business purposes.

The business relationship between the toll free service provider and toll-free subscriber will be driven by market forces. In addition, if the toll-free service provider is not owned by the same entity as the owner of the access network, a fee arrangement or business model may need to be established between the toll-free service provider and the access network provider. The business model for either of these business models may be one of the following business models, a combination of more than one of the following business models, or variations of the one of the following business models. The business models include: 1) a block prepay based on number of connects; 2) a pay-per-use based on a number of connects; 3) a pay based on a volume of connects; 4) a pay based on bandwidth usage; 5) a pay based on a type of access network used; 6) a pay based on the type of computing device used by user, 7) a pay based on the user priority, or 8) a pay by the hour, etc. Any business model established between the toll-free service provider and the toll-free subscriber may be supported by the present invention.

The toll-free client 204, which ends up being installed on the computing node 202, may be distributed in a number of ways. The toll-free client 204 is an application, e.g., a software application, which is executed by the computing node 202. The toll-free client 204 may be stored on a removable memory media and may be mailed to users or be provided to users at businesses that sell computing nodes 202. In an embodiment of the invention, the toll-free client 204 may be stored on a smart-card and distributed to users. In an embodiment of the invention, the toll-free client 204 may be installed on a subscriber identity module (SIM) for cell phones and may be provided to users of cellular phones. The toll-free client 204 may be pre-installed on computing nodes by manufacturers of the computing nodes, dealers selling the computing nodes, or companies which develop application or operating system software for the computing nodes 202. The toll-free client 204 may also be downloaded onto a computing node 202 from a subscriber server 210 or the toll-free management server 220. In an embodiment of the invention where the computing node is a vending machine, a household appliance, or a personal electronic device, the toll-free client 204 may be installed in a ROM or firmware of the machine, appliance, or device.

The computing node 202 may enter an area or geographic location including an access network 206 which allows public access to the global communications network 208. The access network 206 may provide access to the global communications network 208 for a plurality of computing nodes. In an embodiment of the invention, the access network 206 may include a plurality of access points and an access router. The access network 206 may allow a computing node to connect to the global communications network 208 via a wired connection or a wireless connection.

In an embodiment of the present invention, the computing node 202 may be a device such as a vending machine, a household appliance, or a personal electronic device that has capabilities to connect to the Internet. In this embodiment of the invention, the access network 206 may poll the vending machine, household appliance, or personal electronic device to determine if any data or packets need to be transmitted from the vending machine, household appliance, or personal electronic device to a subscriber server 210 through the access network 206 and the global communications network 208. Alternatively, if a certain condition occurs, then the vending machine, household appliance, or personal electronic device may transmit a signal to the access network 206 that it wants to connect to the subscriber server 210. Illustratively, the vending machine or the household appliance may proactively sense a failure of a portion of the device and may want to transmit a signal to a technical support subscriber server indicating that service is required.

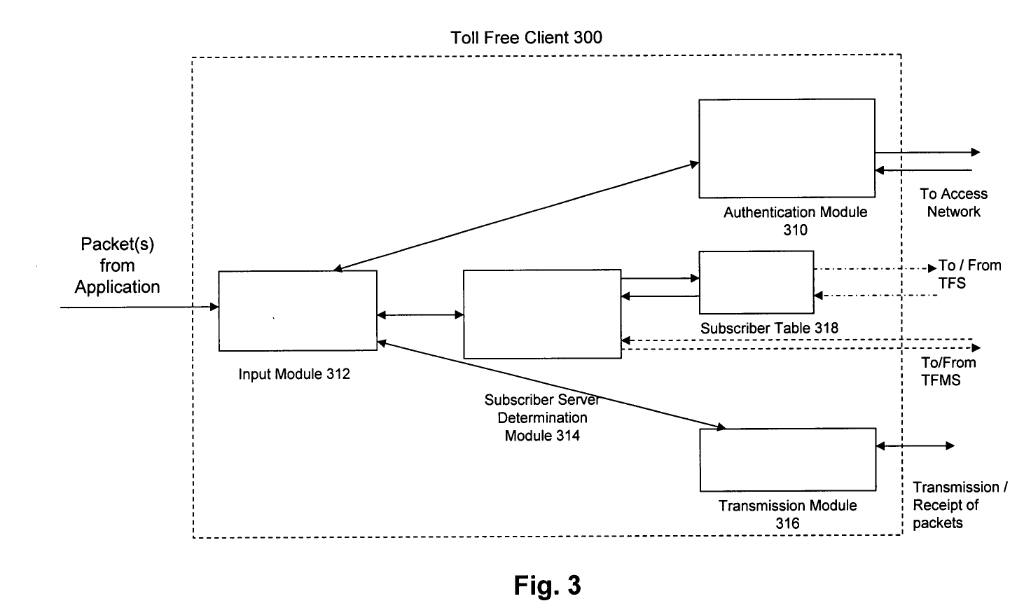

FIG. 3 illustrates a toll free client according to an embodiment of the present invention. The toll free client 300 includes an authentication module 310, an input module 312, a subscriber server determination module 314, and a transmission module 316. In an embodiment of the present invention, the toll free client 300 also includes a subscriber table 318.

After a computing node 202 (see FIG. 2) is enabled and connects to an access network, the authentication module 310 of the toll free client 300 transmits embedded identification information to the toll-free management server 220 (see FIG. 2) to allow the toll-free management server 220 to authenticate this toll free client 300, and the entity operating the toll free client 300, as a valid or registered user. If the toll-free client 300 is authenticated, the toll-free client 300 receives an authentication signal or message.

The toll-free management server (TFMS) 220 transmits an authentication signal or message to the authentication module 310 indicating that the toll-free client 300 may proceed in a logon process. If the toll-free client 300 is not authenticated, the TFMS transmits a signal or message to the authentication module 310 identifying that the toll-free client 300 has not been authenticated. The toll-free client 300 may communicate via any open standard protocol to the toll-free management server 220. Illustratively, the toll-free client 300 may communicate with the toll-free management server 220 utilizing the COPS protocol, the Simple Network Management Protocol (SNMP), the RADIUS protocol, the DIAMETER protocol, or the LDAP protocol. In an embodiment of the invention, the toll-free client 300 may communicate with the toll-free management server 220 through the access network 206 and the global communications network 208 (see FIG. 2).

The authentication module 310 receives the signal identifying the non-authentication of the toll-free client 300 and transmits an error message to the user indicating that the computing node cannot utilize the toll-free service. At this point, the user may choose to take actions to get an updated copy of toll-free client 300 using any one of the methods that the toll-free service provider or toll-free subscriber may offer.

In an embodiment of the invention, the authentication module 310 may transmit a signal, packet, or message to the input module 312 indicating that the input module 312 may receive data, which is normally supplied in the form of network packets. In an embodiment of the invention, the authentication module 310 may transmit a signal, packet, or message to a module in the computing node 202 (see FIG. 2) outside of the toll-free client 300 identifying that the computing node 202 can utilize toll-free services or the services established by the subscriber server 210.

Upon successful authentication, the access network 206 is ready to receive and route network packets from the computing node 202. The routing of network packets may be determined by a means defined between the management server 220 and the access network 206, a means defined between the computing node 202 and the access network 206, or a part of a means between the computing node 202 and the management server 220 through the access network 206. If the access network 206 is a different business entity than the toll free service provider 220, then the access network 206 may start an accounting mechanism in the access network 206 to inform the toll free service provider, (for example, the toll free management server 220) of connection or access attributes (e.g., time of access, duration of access, bandwidth consumed, etc.) of the computing nodes utilizing the access network 206 for toll-free services or other prearranged services.

Once authentication is complete, an application on the computing node 202 may generate a plurality of network packets. Under certain operating conditions, the plurality of network packet(s) may be generated by the user of a computing node 202 or an application resident on the computing node 202. Under other operating conditions, the network packets may be generated after predetermined conditions have occurred, as discussed previously in regard to vending machines, household appliances, or personal electronic devices. In addition, the toll-free client 300 itself may generate a network packet.

The plurality of network packets may be transferred from the application on the computing node 202 to the input module 312. The input module 312 may include be a buffer within the toll-free client to store the plurality of network packets. In an embodiment of the present invention where the toll-free client is stored on a media which is inserted into the computing device, the input module 312 may include a memory, such as a RAM, ROM, on a smart card, memory card, etc. A destination packet is transferred to the subscriber server determination module 314. As discussed previously, the destination packet may be the first packet of the plurality of network packets, may be a packet other than the first packet, may be a plurality of network packets including the first network packet, or may be a plurality of network packets not including the first network packet.

The subscriber server determination module 314 identifies whether destination identification information, e.g., a destination IP address, of the destination packet is a registered destination identification of a valid or registered subscriber server 210. The subscriber server determination module 314 receives the destination packet from the input module 312. Under certain operating conditions, the subscriber server determination module 314 may extract destination identification information or destination information from the destination packet and may transmit the destination identification information to the toll free management server 210. Illustratively, the destination identification information may be an IP address or a URL. Under certain operating conditions, the server determination module 314 may transmit the destination packet, rather than or in addition to, the destination identification information, to the toll-free management server 220 (TFMS).

The TFMS 220 may receive the destination identification information from the subscriber server determination module 314. The TFMS 220 may verify that the destination identification information corresponds to a valid or registered toll-free subscriber server 210. Illustratively, if the destination packet utilizes an IP address as its destination identification and the IP address is for a server located at Toshiba America Technical Support Center, the TFMS 220 determines whether Toshiba America Technical Support Center is a valid or registered subscriber, i.e., has registered with the TFMS 220. If the TFMS 220 determines that the destination identification is one corresponding to a registered subscriber, the TFMS 220 transmits an authorization signal or message to the subscriber server determination module 314 in the toll-free client 300. If the TFMS 220 determines that the destination identification is not one corresponding to a registered subscriber, then the TFMS 220 transmits a non-authorization signal to the subscriber server determination module 314 of the toll-free client 300.

If an authorization signal is received by the subscriber server determination module 314, then the subscriber server determination module 314 transmits a transmission signal to the input module 312 indicating that the network packets with the authorized destination identification information or destination information should be allowed to be transmitted to the subscriber server 220. The input module 312 receives the transmission signal and allows all network packets with the authorized destination identification information to be sent to the transmission module 316. In other words, the input module 312 acts as a filter and allows passage of all packets with the authorized destination identification information or destination information to be transmitted to the transmission module 316. The transmission module 316 receives the packets with the authorized destination identification information, prepares the network packets for transmission to the subscriber server 220, and transmits the network packets to the subscriber server 220.

In an embodiment of the invention, the toll free client 300 may include a subscriber table 318. In this embodiment of the invention, the validity of the subscriber server 210 as a subscriber, i.e., whether the subscriber server is registered to allow toll-free access, is determined within the toll free client 300, i.e., the toll free management server 220 is not utilized. The subscriber table 318 may be pre-loaded into a buffer of the toll free client 300. The subscriber table 318 may include a list of destination identification information or destination information corresponding to the registered subscriber servers. Illustratively, the subscriber table 318 may include a list or URLs or IP addresses for valid or registered subscribers.

The subscriber table 318 may be updated from the toll-free management server 220 in a variety of manners. A computing device 202 may automatically update the subscriber table 318 every time the computing node 202 logs on or logs off the global communication network 208 (see FIG. 2). In this embodiment, the computing node 202 may communicate with the toll-free management server 220 and may receive an update for the subscriber table 318 during logon or logoff. In an alternative embodiment of the invention, a user of the computing node 202 may receive an update for the subscriber table 318 on a magnetic media, optic, or static-electrical media, such as a CD, diskette, DVD, smart card, SIM module, etc. This update may be provided to the user of the computing node 202 periodically.

In this embodiment of the invention utilizing the subscriber table 316, the subscriber server determination module 314 may transmit the destination packet or the destination identification information to the subscriber table 318. The subscriber table 318 may receive the destination identification information and may verify if the destination identification information corresponds to a valid or registered subscriber server 210. More specifically, the subscriber table 318 determines whether the destination identification information for a valid or registered subscriber server 220 is located with the subscriber table 318. Illustratively, the subscriber table 318 may verify that the IP address or URL is one for a server that has subscribed to allow toll-free services or other pre-arranged services and to bear the connection costs of providing the services.

If the destination identification information corresponds to a valid subscriber, i.e., subscriber server 210, the subscriber table 318 transmits an authorization signal or message to the subscriber server determination module 314. The subscriber server determination module 314 receives the authorization signal and transmits a transmission signal to the input module 312 identifying that all network packets having the authorized destination identification information or destination information may be transferred to the transmission module 316 in order for the plurality of network packets to be transferred to the subscriber, or more specifically the toll-free subscriber server 210.

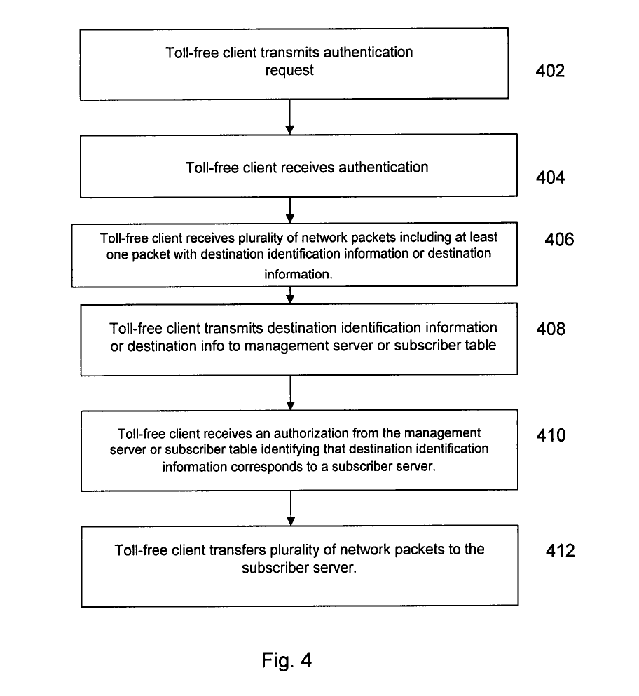

FIG. 4 illustrates a flowchart describing a flow of packets in a toll-free client according to an embodiment of the present invention. A computing node is enabled and a toll-free client in the computing node transmits 402 an authentication request to a toll-free management server or an existing user authentication server. The toll-free client receives 404 an authentication signal from the toll-free management server or the existing user authentication server if a user of the toll-free client is authenticated. The toll-free client receives 406 a plurality of network packets including at least one packet including destination identification information, i.e., receives a destination packet. In one embodiment of invention, the toll-free client transmits 408 the destination identification information included in the at least one packet or destination packet to a toll-free management server to determine whether the destination identification information or destination information corresponds to a toll-free subscriber server. In an embodiment of invention, the toll-free client transmits 408 the destination identification information or destination information from the at least one packet or destination packet to a subscriber table to verify the destination identification information corresponds to a toll-free subscriber server. The toll-free client receives 410 an authorization from the toll-free management server or the subscriber table indicating that the destination identification information corresponds to a toll-free subscriber server. After receipt of the authorization signal, the toll-free client transfers 412 the plurality of network packets to the subscriber server.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A system to provide toll-free or reduced toll Internet access, comprising:
a computing node configured to generate and transmit a destination packet having destination information indicative of a subscriber server with which the computing node is to communicate;
an access network for receiving the destination packet transmitted by the computing node and forwarding the destination packet; and
a management server on which one or more subscriber servers for providing toll-free or reduced toll Internet access to the computing node are registered, wherein
said management server receives the destination packet forwarded by the access network and determines whether the destination information is indicative of the registered subscriber server.

2. The system of claim 1, wherein the management server transmits an authorization to the computing node when a determination is made that the destination information is indicative of the registered subscriber server.

3. The system of claim 2, wherein after receipt of the authorization, the computing node communicates toll-free or at a reduced toll with the registered subscriber server via an exchange of network packets.

4. The system of claim 1, wherein the management server transmits a non-authorization to the computing node when a determination is made that the destination information is not indicative of the registered subscriber server and the computing node does not communicate toll-free or at a reduced toll with the registered subscriber server via an exchange of network packets.

5. The system of claim 1, wherein the computing node generates and transmits an authentication request to the management server before transmitting the destination packet.

6. The system of claim 1, including a plurality of computing nodes, each computing node configured to generate and transmit a destination packet having destination information indicative of a subscriber server with which the computing node is to communicate.

7. The system of claim 1, wherein the access network is coupled to the management server and the one or more subscriber servers over the Internet.

8. The system of claim 1, further including a client to capture a plurality of network packets generated by the computing node including the destination packet and to transmit the destination packet.

9. The system of claim 1, wherein the management server includes a registration table to store destination information indicative of the one or more subscriber servers for providing toll-free or reduced toll Internet access to the computing node.

10. The method of providing toll free or reduced toll internet access, comprising
generating and transmitting a destination packet having destination information indicative of a subscriber server with which a computing node is to communicate;
receiving the destination packet, at an access network, and forwarding the destination packet;
receiving the destination packet forwarded from the access network at a management server, the management server on which one or more subscriber servers for providing toll-free or reduced toll Internet access to the computing node are registered; and
determining whether the destination information is indicative of a registered subscriber server.

11. The method of claim 10, further including transmitting an authorization to the computing node when a determination is made that the destination information is indicative of the registered subscriber server.

12. The method of claim 11, further including communicating toll-free or at a reduced toll with the registered subscriber server, after receipt of the authorization, via an exchange of network packets.

13. The method of claim 10, further including generating and transmitting an authentication request before transmitting the destination packet.

14. The method of claim 10, further including capturing, by a client, a plurality of network packets including the destination packet generated by the computing node, and transmitting the destination packet.

15. A computing node to receive toll-free or reduced toll Internet access, comprising:
a software application to generate a plurality of network packets including at least one packet, the at least one packet including destination identification information; and
a client to receive the plurality of network packets including the at least one packet from the software application, wherein the client transmits the destination identification information to a management server to determine whether the destination identification information corresponds to a subscriber server that is registered with the management server to allow toll-free or reduced toll Internet access to the computing node.

16. The computing node of claim 15, wherein the client receives an authorization from the management server if the destination identification information is determined to correspond to the subscriber server registered with the management server to allow toll-free or reduced toll Internet access.

17. The computing node of claim 16, wherein the client transmits the plurality of network packets to the subscriber server toll-free or at the reduced toll if the client receives the authorization.

18. A computing node to receive toll-free or reduced toll Internet access, comprising:
a software application to generate a plurality of network packets including at least one packet, the at least one packet including destination identification information; and
a client to receive the plurality of network packets including the at least one packet from the software application, wherein the client determines whether the destination identification information corresponds to a subscriber server that is registered to provide toll-free or reduced toll Internet access by utilizing an internal table, wherein the internal table includes a list of subscriber servers registered to allow toll-free or reduced toll Internet access by the computing node.

19. The computing node of claim 18, wherein the client transmits the plurality of network packets to the registered subscriber server if the internal table includes the registered subscriber server.

20. A method of providing toll-free or reduced toll access to a global communications network, comprising:
receiving at least one packet having destination identification information;
transmitting the destination identification information from the at least one packet;
receiving the destination identification information; and
determining whether the destination identification information corresponds to a subscriber server that is registered with the management server to provide the toll-free or reduced toll access to a computing node.

21. The method of claim 20, wherein the management server receives the destination identification information and determines whether the destination identification information corresponds to the registered subscriber server.

22. The method of claim 21, further including the management server transmitting an authorization to a client in the computing node to identify that the destination identification information corresponds to the subscriber server that is registered with the management server to provide toll-free or reduced toll access to the computing node.

23. The method of claim 22 further including transferring the plurality of network from the computing node if the authorization is received by the client in the computing node.

24. The method of claim 21, further including the management server transmitting a non-authorization signal to a client in the computing node if the destination identification information does not correspond to the registered subscriber server.

25. The method of claim 20, wherein the subscriber table receives the destination identification information determines whether the destination identification information corresponds to the registered subscriber server.

26. The method of claim 20 further including authenticating the client and the computing node, before the computing node generates the plurality of network packets, by transmitting an authentication request to the management server and receiving authentication from the management server.

27. The method of claim 20, further including authenticating the client and the computing node, before the computing node generates the plurality of network packets, by transmitting an authentication request to an existing user authentication server and receiving an authentication from the management server.

28. A method to provide toll free or reduced toll Internet access, comprising:
receiving, from a computing node, a destination packet having destination identification information;
transmitting the destination identification information from the destination packet; and
receiving an authorization verifying that the destination identification information corresponds to a subscriber server that is registered to allow toll free or reduced toll Internet access by the computing node.

29. The method of claim 28, wherein the authorization signal is received from a management server.

30. The method of claim 28, wherein the authorization signal is received from a subscriber table.

31. The method of claim 28, further including transmitting a plurality of network packets generated by the computing node, to the subscriber server that is registered to allow toll-free or reduced toll Internet access by the computing node, if the authorization signal is received.

32. The method of claim 28, further including authenticating the client, before a computing node generates a plurality of network packets including the destination packet, by transmitting an authentication request to the management server and receiving an authentication signal from the management server.

33. The method of claim 28, further including authenticating the client, before a computing node generates a plurality of network packets including the destination packet, by transmitting an authentication request to an existing user authentication server and receiving an authentication signal from the existing user authentication server.

34. A computer-readable medium having encoded thereon a computer-readable program code which when executed causes a computing node to:
receive, from a computing node, a destination packet having destination identification information;
transmit the destination identification information from the destination packet; and
receive an authorization verifying that the destination identification information corresponds to a subscriber server that is registered to allow toll free or reduced toll Internet access by the computing node.

35. The computer-readable program code of claim 34 which when executed causes the computing node to transmit the destination identification information from the destination packet to a management server to determine whether the destination identification information corresponds to the registered subscriber server.

36. The computer-readable program code of claim 34, which when executed causes the computing node to utilize a subscriber table within the client to determine whether the destination identification information corresponds to the registered subscriber server.

37. The computer-readable program code of claim 34, which when executed causes the computing node to transmit a plurality of network packets generated by the computing node to the subscriber server if the client receives an authorization signal.

38. The computer readable program code of claim 34, which when executed causes the computing node to authenticate a client before the plurality of network packets are generated by the computing node, by transmitting an authentication request to the management server.

39. A client installed on a computing node, comprising:
an input module to receive a plurality of network packets including at least one packet having destination identification information and the input module to transmit the at least one packet; and
a subscriber server determination module to receive the at least one packet, to extract the destination identification information, and to determine whether the destination identification information corresponds to a registered subscriber server.

40. The client of claim 39, further including a transmission module, wherein if the subscriber server determination module determines that the destination identification information corresponds to the registered subscriber server, the subscriber server determination module transmits a signal to the input module to transfer the plurality of network packets to the transmission module.

41. The client of claim 39, where the subscriber server determination module determines whether the destination identification information corresponds to the registered subscriber server by communicating the destination identification information to a management server to and receives an authorization back from the management server if the destination identification information corresponds to the registered subscriber server.

42. The client of claim 39, wherein the subscriber server determination module determines whether the destination identification information corresponds to a registered subscriber server by checking a subscriber table within the client to verify the destination identification information is included in the subscriber table.

43. The client of claim 39, wherein the subscriber table is updated when a computing node including the client logs on or off an access network which is coupled to the Internet.

44. The client of claim 43, wherein the subscriber table is updated by inserting a magnetic, optic, or static-electrical media including an updated subscriber table into the computing node media reader.

45. The client of claim 39, further including an authentication module to authenticate the client, before the input module receives the plurality of network packets, by transmitting an authentication request to a management server.

46. The client of claim 39, further including an authentication module to authenticate the client before the input module receives the plurality of network packets by transmitting an authentication request to an existing user authentication server.

47. A method of registering as a toll-free subscriber, comprising:
receiving destination identification information from a subscriber server; and
updating a table in a management server to register the subscriber server.

48. The method of claim 47, wherein a subscriber, which controls the subscriber server, establishes a business model with a toll-free service provider, which controls the management server, before or after the subscriber server is registered.

49. The method of claim 48, wherein the business model is one of a block prepay based on number of connects business model, a pay-per-use based on number of connects business model, a pay based on a volume of connects business model, a pay based on bandwidth usage business model, a pay based on a type of access network used business model, a pay based on the type of computing device used by user business model, a pay based on the user priority business model, and a pay by the hour business model.
